(19) United States
(12) Patent Application Publication
(10) Pub. No.: US 2007/0016437 A1
(43) Pub. Date: Jan. 18, 2007

(54) Product pricing system and method for providing multi-dimensional pricing capability for rates, adjustments and fees

(76) Inventors: Laura Elmufdi, Sunnyvale, CA (US); Andrej Buszko, Foster City, CA (US); Darryl Amour, Sunnyvale, CA (US); Lance Davis, South Riding, VA (US); Joe Hallett, Mount Airy, MD (US)

Correspondence Address: STAAS & HALSEY LLP, SUITE 700, 1201 NEW YORK AVENUE, N.W., WASHINGTON, DC, 20005, US

(21) Appl. No.: 11/391,344

(22) Filed: Mar. 29, 2006

Related U.S. Application Data
(60) Provisional application No. 60/666,151, filed on Mar. 29, 2005.
(60) Provisional application No. 60/666,152, filed on Mar. 29, 2005.

(51) Int. Cl. G06Q 99/00

(52) U.S. Cl. 705/1

(57) ABSTRACT

A product pricing system and method thereof, including a computer-implemented pricing engine being a single software application automatically generating prices for different types of products in accordance with pricing attributes for the different types of products provided to the pricing engine by a system administrator via a graphical user interface. When a pricing request is sent to the pricing engine from a product requestor applying for a respective product, the pricing engine automatically generates a price for the respective product in accordance with the pricing attributes provided for the respective product and the pricing request.

### CROSS-REFERENCE TO RELATED APPLICATIONS

This application is related to and claims the benefit of U.S. Provisional Application Serial Number No. 60/666,151, entitled PRICING ENGINE, by Laura Elmufdi et al., filed Mar. 29, 2005, and U.S. Provisional Application Serial Number No. 60/666,152, entitled CONFIGURATION/MULTI-PRODUCT, by Scott Schellhammer et al., also filed Mar. 29, 2005, the disclosures of which are incorporated by reference herein in their entirety.

### BACKGROUND OF THE INVENTION

### Description of the Related Art

Companies and other entities typically offer many different types of products to consumers. For example, a bank might offer auto loans and credit cards to consumers. Other types of products offered to consumers include insurance policies and investment vehicles.

Each different type of product typically requires a completely separate system or department to price the product. For example, if a bank offers auto loans and credit cards, the bank would have a separate department or system to price (for example, set an interest rate and payment schedule) the auto loan and a separate department to price (for example, set an interest rate) the credit card.

Unfortunately, the use of separate departments or systems to price different products is inefficient, expensive and time consuming.

### BRIEF DESCRIPTION OF THE DRAWINGS

Aspects and advantages of the invention will become apparent and more readily appreciated from the following description of the preferred embodiments, taken in conjunction with the accompanying drawings of which:

FIG. 1 is a diagram illustrating a product pricing system, according to an embodiment of the present invention;

FIG. 2 is a diagram illustrating a pricing engine of the product pricing system shown in FIG. 1, according to an embodiment of the present invention.

FIG. 3 is a diagram illustrating a pricing engine service unit of the pricing engine as shown in FIG. 2, according to an embodiment of the present invention;

FIG. 4 is a flowchart illustrating a method for determining prices for different types of products via a computer, according to an embodiment of the present invention;

FIG. 5 is a flowchart illustrating a method of automatically processing the pricing request according to an embodiment of the present invention as shown in FIG. 4, according to an embodiment of the present invention;

FIG. 6 is an entity relationship model diagram illustrating a pricing strategy of the pricing engine, according to an embodiment of the present invention;

FIG. 7 is a flowchart illustrating how to set up pricing attributes in the pricing engine, according to an embodiment of the present invention;

FIG. 8 is a computer display illustrating how applicability rules for adjustments can be entered in the pricing engine, according to an embodiment of the present invention;

FIG. 9 is a computer display illustrating how applicability rules for fees can be entered in the pricing engine, according to an embodiment of the present invention;

FIG. 10 is a computer display illustrating how to define an index in the pricing engine, according to an embodiment of the present invention;

FIGS. 11A and 11B are computer displays illustrating how to define a rate matrix in the pricing engine, according to an embodiment of the present invention;

FIG. 12 is a computer display illustrating how a rate set is entered in a rate matrix in the pricing engine, according to an embodiment of the present invention; and

FIG. 13 is a chart illustrating an example of a rate matrix, according to an embodiment of the present invention.

### DESCRIPTION OF THE PREFERRED EMBODIMENTS

Accordingly, it is an aspect of the present invention is to provide a generic pricing engine which is configurable to handle any type of pricing request. The pricing engine being capable of calculating a final price for a pricing request or return multiple pricing options depending on information which is supplied to the pricing engine.

The foregoing and/or other aspects of the present invention are achieved by providing a pricing engine, which is highly configurable, such that rate matrices, adjustments and fee determination and applicability are all configurable. In addition, the type of customer information used to determine the rate from the rate matrices, adjustments, and fees are also configurable. Further, multiple rating configuration can be active at the same time through the use of effective dating the rate matrices, adjustments and fees.

Reference will now be made in detail to the present preferred embodiments of the present invention, examples of which are illustrated in the accompanying drawings, wherein like reference numerals refer to like elements throughout.

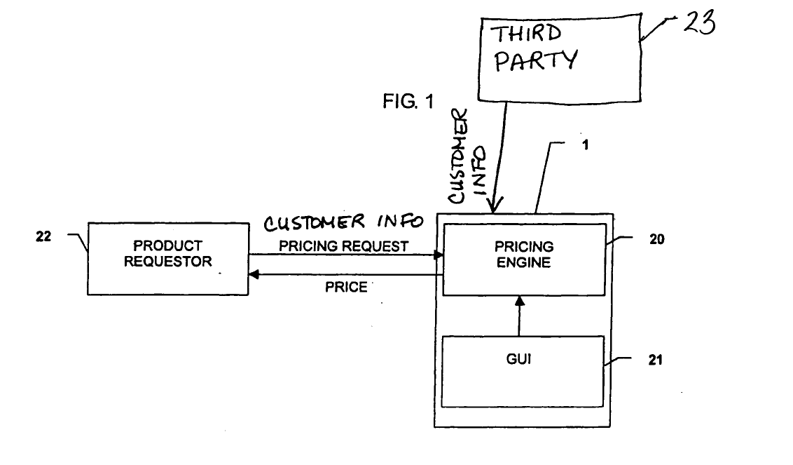

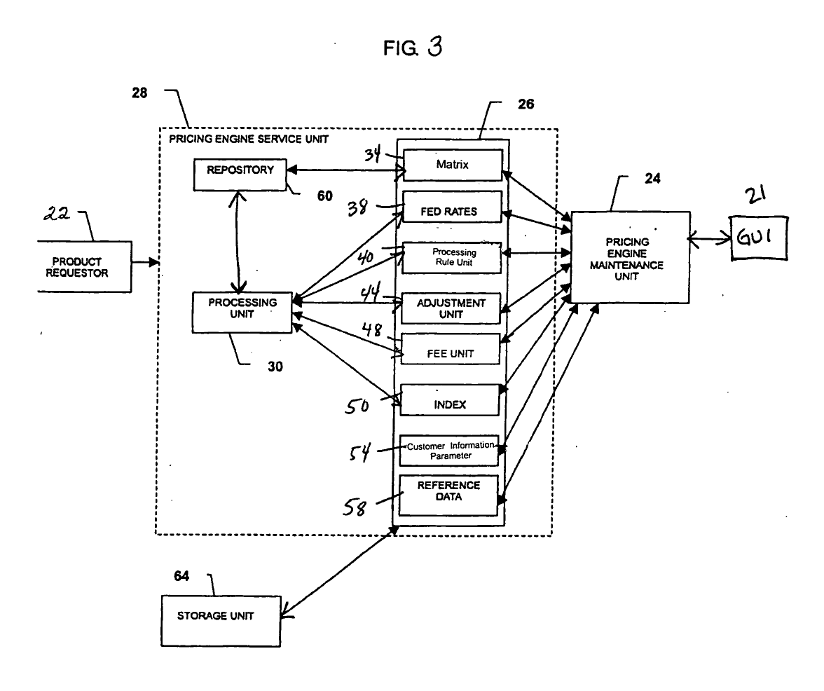

FIG. 1 is a diagram illustrating a product pricing system according to an embodiment of the present invention. In FIG. 1, the product pricing system 1 comprises a computer-implemented pricing engine 20 being a single software application automatically generating prices without any manual computation for different types of products in accordance with customer information and pricing attributes 26 (as shown in FIG. 3) for the different types of products provided to the pricing engine 20. The customer information can be provided to the pricing engine 20 from a product requestor 22 or a third party 23, or from both. The pricing attributes 26 are any data, which can be used to configure a pricing strategy (to be described in detail below). Pricing attributes 26 are provided to the pricing engine 20 by a system administrator (not shown) via a graphical user interface (GUI) 21. Pricing of the product will depend on how the pricing strategy is configured. Since the pricing engine 20 is a single software application configurable to be used for different types of products, only one pricing engine is necessary for multiple different types of products. Further, the pricing engine 20, according to an embodiment of the present invention, would typically be a stand-alone system, which can operate independently of any external system connected thereto.

As mentioned above, the pricing engine 20 generates prices without manual computation for different types of products. A product is considered any good or service having a pricing component. That is, the different types of products can be, for example, any originating products having a pricing component, such as, for example, a credit card loan, an auto loan, an insurance policy or a mortgage. However, the present invention is not limited to any particular types of products. Further, the present invention is not limited to accept any particular type of customer information. Thus, attributes within the pricing engine 20 can be configured to be any particular type of customer information and product information. Therefore, the pricing engine 20 may be customized to meet the needs of the financial institution or product offerer.

When a pricing request is sent to the pricing engine 20 from a product requestor 22 applying for a respective product, the pricing engine 20 automatically generates without any manual computation a price for the respective product in accordance with customer information and the pricing attributes 26 provided for the respective product and the pricing request. A price includes a cost for receiving a product, the cost including any applicable adjustments and fees.

The product requestor 22 may be, for example, an applicant applying for the respective product or an external system interfacing with the pricing engine 20. However, the product requestor 22 is not limited hereto, and may vary, as necessary. The pricing engine 20 uses the customer information received from the product requestor 22 and/or the third party 23 to generate the price. Customer information comprises any information related to the customer, product or application which can be used to determine the price. The customer information might include, for example, a FICO score, customer name, employer name, address or location information, income information, product applied for, and duration of loan. Customer information can also be provided by the third party 23. For example, the FICO score can be retrieved by the pricing engine 20 from a third party 23, such as a third party credit source (not shown). However, the present invention is not limited to the customer information being any particular type of information.

According to an embodiment of the present invention, the customer information might not be permanently stored in the pricing engine 20. Instead, it might be stored within an external system connected to the pricing engine 20. However, the present invention is not limited in this manner, and may vary accordingly. In another embodiment of the present invention, the customer information may be stored within the pricing engine 20, for example, in a storage unit 64 (as shown in FIG. 3)

Further, in FIG. 1, the generated price for the respective product comprises, for example, a single final price or multiple pricing options in accordance with the pricing request. The pricing engine 20 will determine based on the input information it receives whether a single price or multiple pricing options will be generated.

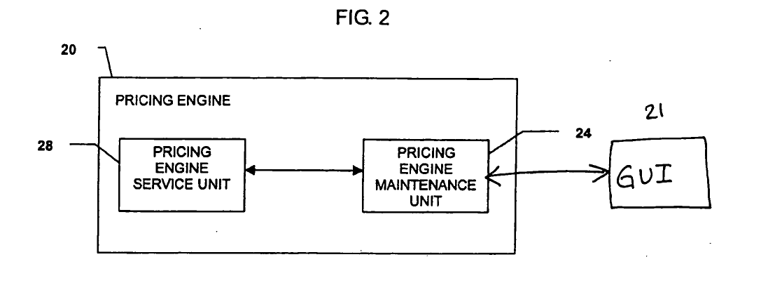

FIG. 2 is a diagram illustrating the pricing engine as shown in FIG. 1, according to an embodiment of the present invention. In FIG. 2, the pricing engine 20 comprises, for example, a pricing engine maintenance unit 24 to enter and maintain the pricing attributes 26 (shown in FIG. 3), and a pricing engine service unit 28 to determine the price for the respective product based upon the pricing request. The pricing engine maintenance unit 24 interfaces with the pricing engine service unit 28 such that information stored in the pricing engine service unit 28 is updated in accordance with the pricing attributes 26 maintained in the pricing engine maintenance unit 24. A system administrator is granted user access based, for example, upon an access control list created to validate user authority, wherein the access control list is maintained in an external system connected with the pricing engine 20, to provide access to the pricing engine maintenance unit 24 via the GUI 21. However, the present invention is not limited any particular type of authentication tool, and may vary as necessary. Moreover, the present invention is not limited to the pricing engine 20 including the pricing engine service unit 28 and/or the pricing engine maintenance unit 24.

FIG. 3 illustrates a pricing engine service unit of the pricing engine as shown in FIG. 2, according to an embodiment of the present invention. In FIG. 3, the pricing engine service unit 28 comprises of a processing unit 30, a repository unit 60, and additional units (to be discussed in detail below), which store and manage the pricing attributes 26. Pricing attributes 26 are configurable by the system administrator, and comprise rate matrices and pricing parameters. The pricing parameters include adjustments including adjustment parameters, fees including different types of fees and fee amounts.

The processing unit 30 acts to control all processing within the pricing engine 20. As shown in FIG. 3, the processing unit 30 interacts with the repository unit 60 to retrieve applicable rate information from a matrix unit 34. Further, the processing unit 30 interacts with a federal rates unit 38 to retrieve federal interest rate information.

The processing unit 30 also interacts with a processing rule unit 40 to retrieve a processing rule (see Table 1 below) to use for the pricing strategy, and to interpret the processing rule.

In addition, the processing unit 30 interacts with an adjustment unit 44, to determine if there are applicable adjustments and return any applicable adjustments back to the processing unit 30. Similarly, the processing unit 30 also interacts with a fee unit 48, to determine if there are applicable fees and return any applicable fees and a disposition of the applicable fees. Further, the processing unit 30 interacts with an index unit 50 to retrieve index rates and use a retrieved index rate in calculating the final price.

As shown in FIG. 3, the repository unit 60 receives a pricing request to retrieve rate information from the processing unit 30. The repository unit 60 retrieves and evaluates an applicable rate matrix from the rate matrices stored in the matrix unit 34, and transfers any applicable rate to the processing unit 30. The repository unit 60 uses a processing date provided in the pricing request to determine the effective rate matrix. The repository unit 60 then uses any relevant customer, application or product information provided in the pricing request to determine which rate or rates would be applicable based on the effective rate matrix. The processing unit 30 receives any applicable rates from the repository unit 60 and calculates a final rate or set of rates corresponding to the pricing request.

When there are no applicable rates, the repository unit 60 notifies the processing unit 30 that no applicable rates exist.

As mentioned above, the matrix unit 34 is used to store the multi-dimensional matrices created in the pricing engine maintenance unit 24 via the GUI 21 by a system administrator. The multi-dimensional pricing matrices are configurable using customer info parameters stored in a customer information parameters unit 54, to define the multiple dimensions of the rate matrix.

The adjustment unit 44 stores the adjustments and the rules for receiving adjustments which are entered by a system administrator via GUI 21. The adjustments are not hard-coded and may be configured on the fly. Further, adjustments are any additions or subtractions to the generated rate or rates included in the price. Adjustments values and conditions are entered into the pricing engine 20 by a system administrator via GUI 21.

The fee unit 48 stores the fees entered in the pricing engine maintenance unit 24. For example, if the product is a mortgage, the fees may include fees such as processing fees and appraisal fees. However, the present invention is not limited to any particular type of fees, and may vary as necessary. Similar to adjustments, fees are also not hard-coded and may be configured on the fly.

As mentioned above, the processing unit 30 determines whether fees and adjustments are applicable. When the fee or adjustment is defined, the method of determining if it is applicable is also created. Thus, when calculating the price, the pricing engine service unit 28 evaluates a fee/adjustment applicability rule using customer, application, or product information to determine if a fee and/or adjustment should be used in calculating the price. When applicable, the pricing engine service unit 28 calculates the applicable fees and adjustments and determines a disposition of the applicable fees. However, the present invention is not limited hereto, and may vary as necessary.

Further, in FIG. 3, the pricing parameters of the pricing attributes 26 also comprise indices and federal rates which are automatically retrieved by the pricing engine from an external source (such as a federal web site) or input by the system administrator.

The federal rate unit 38 stores federal rates. Applicable federal rates are determined based on loan term and a request date of the pricing request. The federal rates comprise at least one of published Home Mortgage Disclosure Act (HMDA) rates and Home Ownership and Equity Protection Act (HOEPA) rates. Therefore, upon request, the pricing engine 20 may return federal rate information associated with the generated price. The present invention is not limited to any particular types of federal rates, and may vary as necessary.

The index unit 50 stores the indices entered in the pricing engine maintenance unit 24. The indices include at least one published index, for example, 1 year T-bill, LIBOR, or COFI. The indices are input to variably calculate the price, such that when variably calculating the price, the pricing engine 20 generates a variable price and an index from the indices used to determine the variable price. The present invention is not limited any particular types of indices, and may vary, as necessary.

The customer information parameters unit 54 stores pricing criteria to be input by the product requester 22, for example, a FICO score. That is, the customer information parameters unit 54 stores customer information parameters, which define what kind of customer information to be used when creating the multi-dimensional matrices, fees, and adjustments.

The pricing engine service unit 28 further comprises a reference data unit 58 to store application reference data used to create drop down lists to be used by the system administrator in order to create the multi-dimensional matrices.

The processing rule unit 40 determines an evaluation process (i.e., the processing rule) for the processing unit 30, and whether fees or adjustments are applicable, and forwards the determined evaluation process to the processing unit 30, in order to calculate the price. Table 1 below illustrates an example of a processing rule.

TABLE 1
A Processing Rule

```
Retrieve the applicable rate(s) from the effective rate matrix
Retrieve the applicable fees with calculated values and applicable
disposition
Retrieve the applicable adjustments with calculated values
Retrieve the HMDA rate
Retrieve the HOEPA rate
For each rate set returned
  If there is a variable rate
    Retrieve the associated index
  For each rate within the rate set
    Calculate the adjustment total for the rate
    Calculate the final rate based on rate, index, and adjustment total
Format output
```

The processing rule as shown in Table 1, for example, instructs the processing unit 30 to retrieve the applicable rate(s) from the effective rate matrix; retrieve the applicable fees with calculated values and applicable disposition thereof; retrieve the applicable adjustments with calculated values; retrieve HMDA and HOEPA rates; for each rate set returned, if there is a variable rate, retrieve the associated index; and for each rate within the rate set, calculate the adjustment total for the rate; and then calculate the final rate based on the rate, index, and adjustment total and format the output.

The pricing engine service unit 28 further comprises a storage unit 64 to store the pricing attributes 26. The pricing attributes 26 are cached via the pricing engine service unit 28, for example, to avoid unnecessary request to the storage unit 64. However, the present invention is not limited hereto, and may vary as necessary.

The pricing engine 20 configures and maintains the rate matrices, and determines when the rate matrices are to be effective, to thereby allow stacking of rate matrices. For example, when promotions are offered, the promotions override any active base rate matrix. The pricing engine also includes individual effective-dating of adjustments and fees. Specifically, the pricing engine maintenance unit 24 automatically prioritizes and overlaps the rate matrices, adjustments, and fees, to thereby allow different rate matrices, adjustments, and fees to be active for a predetermined time period. For example, a promotional offer including promotional rates may be active and overlapping any existing base rates and expire after a predetermined time period, to thereby allow the existing base rates to be active.

The rate matrices are created to determine the price for the respective product, and the adjustment parameters and fees are input to enable a change to the price based on the pricing request. For example, Table 2 below illustrates a credit card matrix according to an embodiment of the present invention.

TABLE 2
CREDIT CARD RATE MATRIX

| | Loan | Num Revolving | | | Fico | |
|---|---|---|---|---|---|---|
| Product | Amount | Trades | Campaign | Region | Score | Rate |
| Affinity Classic | 3000 | 0-100 | 3 | North | 0-800 | 12.4 |
| Master Card | | | | East | | |
| Co-Branded Visa | 5000 | 0 | 1 | North | 0-600 | 10.9 |
| Gold | | | | West | | |
| Co-Branded Visa | 5000 | 0 | 1 | North | 601-800 | 12.9 |
| Gold | | | | West | | |
| Co-Branded Visa | 5000 | 0 | 1 | South | 601-800 | 11.4 |
| Gold | | | | West | | |
| Co-Branded Visa | 5000 | 1-100 | | North | 0-800 | 11.9 |
| Gold | | | | West | | |

As shown in Table 2, the system administrator may configure a rate matrix to include columns for ‘Product’, ‘Loan Amount’, ‘Num of Revolving Trades’, ‘Campaign’, ‘Region’, ‘FICO score’ and ‘Rate’. The ‘Product’ column, for example, may include different types of credit cards such as Affinity Classic Master Card and Co-Branded Visa Gold. The ‘Loan Amount’ column may include different amounts for the loan request, such as $3000 and $5000. The ‘Num Revolving Trade’ column may include different amounts of existing accounts for a customer with revolving value, for example credit cards, such as 0, 1, or 50. The ‘Campaign’ column may include different marketing campaign values, such as 1 or 3. The ‘Region’ column may include different regions of the country the pricing request is for, such as North East, North West or South West. Further, the ‘Rate’ column may include the applicable rates for each product. The present invention is not limited in any manner to this particular matrix or this particular example. Moreover, as mentioned above, the present invention is not limited to any particular product, and may comprise any origination product having a pricing component.

The generated price for the respective product comprises, for example, a single final price or multiple pricing options in accordance with the pricing request. The pricing engine 20 will determine based on the input information it receives whether a single price or multiple pricing options will be generated. For example, using the example rate matrix in Table 2 above, if the customer information provided to the pricing engine includes product of Co-branded Visa Gold, loan amount of $5000, with zero revolving trades, and the North West region, the pricing engine will return the rates applying to this customer information for all Campaigns and FICO scores. The pricing engine 20 returns 10.9 and 12.9 for the primary rate in the example rate matrix. However, if in addition a Campaign of 1, a FICO score of 700 is also provided to the pricing engine 20, the returned value will be a rate of 12.9. Depending on the pricing strategy, the generated price might include more than one generated rate. For example, if the respective product is a loan, the generated price might include at least one of a primary rate, a cash rate, a purchase rate, a loan discount rate, a loan origination rate, or an intro note rate and/or duration thereof. However, the present invention is not limited to any particular type of rate, and may vary as necessary.

An example of a mortgage loan process via the pricing engine 20 according to an embodiment of the present invention as shown in FIG. 3, will now be described in detail. However, the present invention is not limited to any particular type of product or order of processing, and may vary as necessary.

Referring to FIG. 3, when a product requester 22 applies for a mortgage via an external system (not shown) connected with the pricing engine 20, the product requestor 22 inputs customer information, for example, a FICO score of 700 and an annual income of $125,000. A pricing request based upon the customer information is then forwarded to the pricing engine service unit 28 to be used in determining a final price or a set of prices based upon the pricing request.

Based upon the pricing request, the processing unit 30 obtains a processing rule from the processing rule unit 40 to be used when calculating the price. For example, the processing rule may include whether the price should be a final price or a set of prices, whether an adjustment is applicable, whether fees should be assessed, and/or whether to return associated federal rates with the calculated price to the product requestor 22. The repository unit 60 then evaluates the rate matrices stored in the matrix unit 34 and selects any applicable rates corresponding to customer information. The repository unit 60 then forwards any applicable rates selected to the processing unit 30.

Based upon the processing rule, the processing unit 30 then retrieves any applicable fees from the fee unit 48, the adjustment parameters from the adjustment unit 44 and any federal rates from the federal rate unit 38. The processing unit 30 then calculates a price and makes adjustments to the price when applicable, and attaches any applicable fees, and automatically generates either a final price, for example, a 30-year mortgage at an interest rate of 6.0% or a set of prices (i.e., pricing options), for example, a 15-year mortgage at an interest rate of 4.5% with one loan origination point and a 30-year mortgage at an interest rate of 5.0% with two loan origination points, and associated federal rates, based upon the pricing request.

The present invention is not limited to a pricing engine including the specific units in FIG. 3. Instead, the units included in a specific embodiment of a pricing engine would be determined in accordance with the specific types of products being offered and priced, and in accordance with the specific manner in which the products are to be priced.

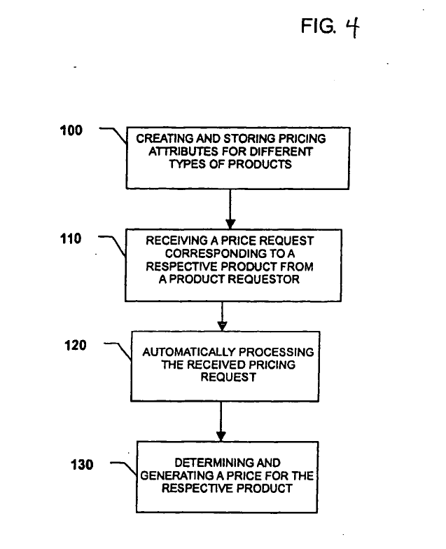

FIG. 4 is a flowchart illustrating a method for determining prices for different types of products via a computer, according to an embodiment of the present invention. As shown in FIG. 4, in operation 110, a pricing request is received corresponding to a respective product from a product requestor. From operation 110, the process moves to operation 120, where the received pricing request is automatically processed. From operation 120, the process moves to operation 130, where a price for the respective product corresponding to the created, stored pricing attributes for the respective product and the received pricing request is determined and generated.

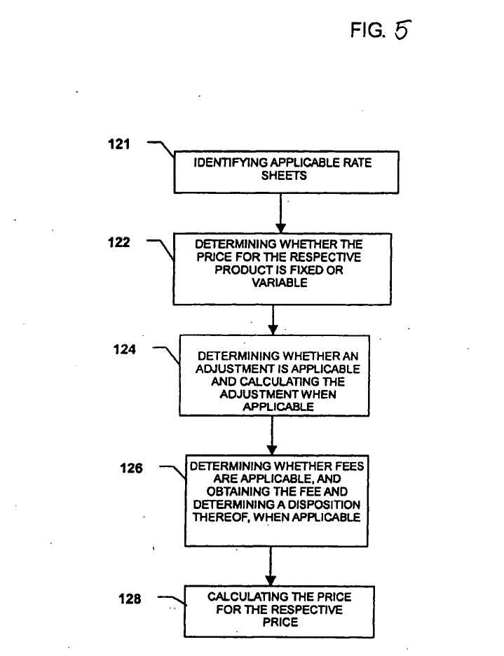

FIG. 5 is a flowchart illustrating of a method of automatically processing the received pricing request (i.e., corresponding to operation 120 shown in FIG. 4). In FIG. 5, in operation 121, applicable rate sheets are identified. From operation 121, the process moves to operation 122, where it is determined whether the price for the respective product is to be a fixed price or a variable price. When it is determined that the price for the respective product is to be a variable price, a published index is retrieved and the variable price is determined based upon the published index retrieved.

From operation 121, the process moves to operation 124, where it is determined whether an adjustment is applicable, and an adjustment is calculated when applicable. From operation 124, the process moves to operation 126, where it is determined whether a fee is applicable, and a fee is obtained, and a disposition thereof is determined, when applicable. From operation 126, the process moves to operation 128, where the price for the respective product is calculated.

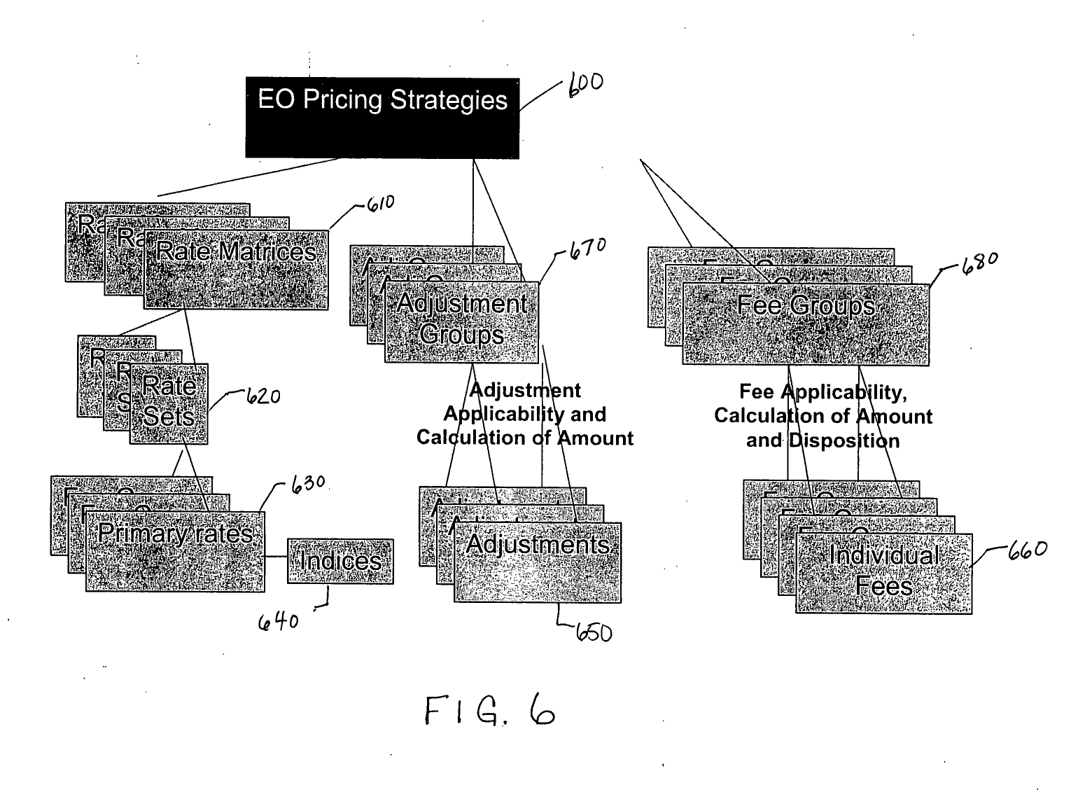

FIG. 6 is an entity relationship model diagram illustrating a pricing strategy 600 of the pricing engine, according to an embodiment of the present invention. A pricing strategy is a set of data configuration/parameters within the pricing engine used to determine and calculate the price for a given pricing request. Specifically, FIG. 6 illustrates the relationships between pricing strategies 600, rate matrices 610, rate sets 620, rates 630, indices 640, adjustments 650, fees 660, adjustment groups 670 and fee groups 680. A pricing strategy 600 can be connected to multiple rate matrices 610, adjustment groups 670 and fee groups 680. Each rate matrix 610 can be connected to multiple rate sets 620 and each rate set 620 can have multiple rates 630. Each rate 630 can be tied to an index 640. Further, the fees 660 and adjustments 650 may be grouped together to form fee groups 680 and adjustment groups 670, respectively, to thereby allow an applicable fee and/or adjustment to be shared among different pricing strategies 600. Groups identify the set of fees 660 and adjustments 650 that are applicable to a particular loan or product. Fee groups 680 and adjustment groups 670 are not effective-dated, only the individual fees 660 and adjustments 650 are effective-dated. Each component of a pricing strategy 600 will be further defined below.

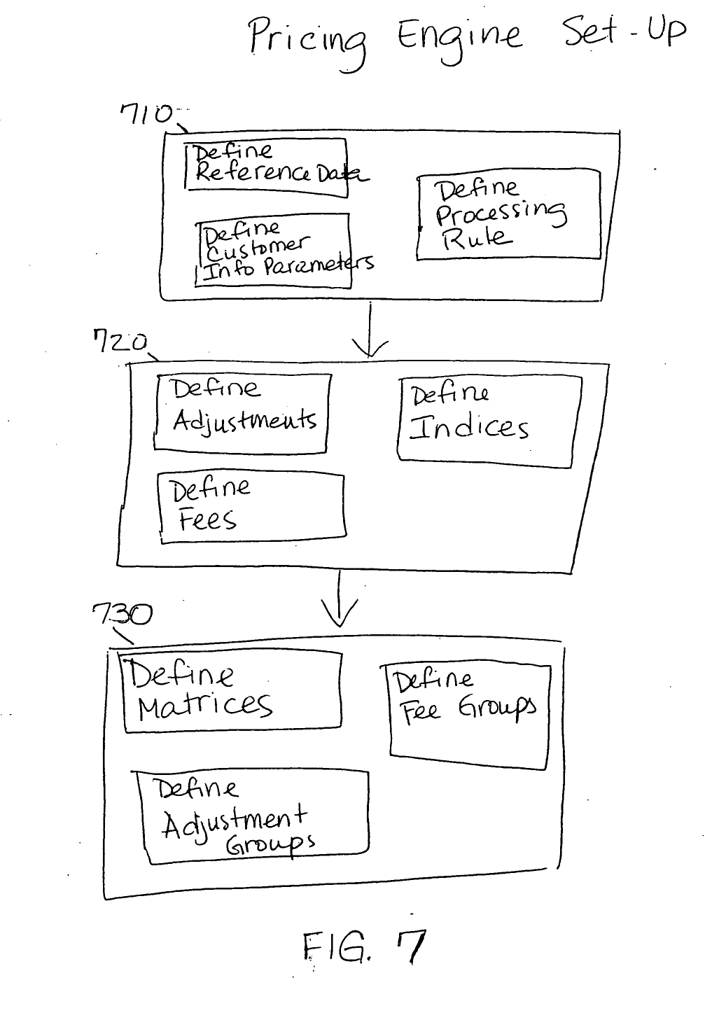

FIG. 7 is a flowchart illustrating how to set up pricing attributes in the pricing engine, according to an embodiment of the present invention. As shown in FIG. 7, for example, the pricing attributes 26 are set up by a system administrator via the GUI 21. In operation 710, the reference data, customer information parameters and processing rules are defined. The order in which this information is set up may vary, as necessary. However, the information in operation 710 must be defined before proceeding to the next operation (i.e., operation 720).

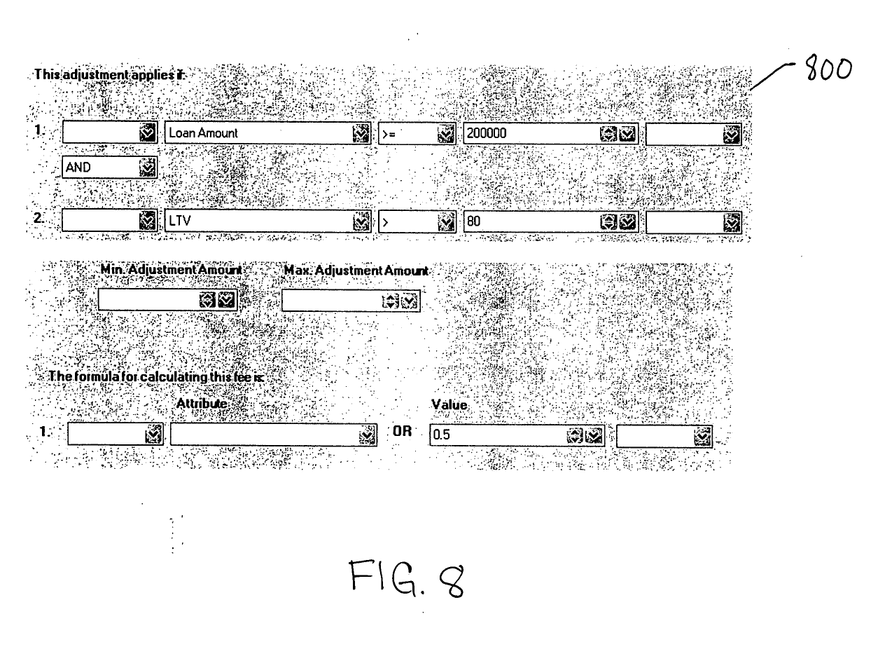

Reference data is key value pairs data used for ease of display and use within the GUI 21. For example, reference data are operations such as ‘=, >, <, >=, <=’. The reference date is used when defining applicability rules for adjustments, as shown in FIG. 8, for example. Once defined and created, the reference data is stored within the pricing engine 20, for example, in the reference data unit 58.

Customer information parameters are used in defining the rate matrix, processing rules, adjustments and fees. The system administrator can define any field related to a customer, product, or application, as a customer information parameter to be used to determine the price for the pricing request. Customer information parameters are stored in the pricing engine 20, for example, within the storage unit 64 as shown in FIG. 3.

Processing rules as shown in Table 1 above, are created to indicate the order and configure the steps for the pricing engine 20 to determine a price. System Administrators can modify the processing rules to configure the process for determining a price. Processing rules are also stored within the pricing engine 20, for example, within the processing rule unit 40.

From operation 710, the set up process moves to operation 720, where adjustments, fees and indices are created. Adjustments are used to increase and decrease all of the rates such as primary, cash, purchase, loan discount, loan originations and other defined rates. Adjustments are defined independently of the rate and fees.

Adjustments can be effective-dated so that multiple adjustments are active at the same time. Adjustments contain two components: applicability and calculation. Adjustment applicability defines whether an adjustment should be applied to the selected rate, and calculation of the adjustment determines the amount to adjust the rate by or how much the adjustment should be.

Adjustment applicability (i.e., a condition for receiving an adjustment) is a rule defined using Boolean logic. However, the rule definition is not limited to Boolean logic. If the rule results in a positive or true outcome, the adjustment will be applied to the selected rate. If the rule results in a negative or false outcome, the adjustment will not be applied to the selected rate.

In the calculation of adjustments, mathematical operations can be used within the rule to calculate the adjustment amount. Negative calculation can be provided to cause a deduction or discount to the selected rate. A minimum or maximum adjustment amount can be provided but is optional. Minimum and maximum adjustment amounts provide upper and lower boundaries on the adjustment amount, to prevent the adjustment amount from going too high or low. If the calculated adjustment amount falls below the minimum, the minimum value is used. If the calculated adjustment amount falls above the maximum, the maximum value is used. Both the condition for receiving an adjustment and the calculation of the adjustment amount can use any customer information parameters. However, the present invention is not limited to any particular adjustment parameters.

Further, in FIG. 7, from operation 720, the set up process moves to operation 730, where matrices, adjustment groups and fee groups are then created.

FIG. 8 is a computer display 800 illustrating how applicability rules for adjustments can be entered in the pricing engine, according to an embodiment of the present invention. The applicability rule example shown in FIG. 8, indicates that if the customer's loan amount is greater than or equal to 200,000 and the Loan-to-Value (LTV) percentage is greater than 80, then the outcome will be an adjustment of 0.5 as indicated in lower portion of FIG. 8. To create this rule, in line 1, the system administrator selects customer information parameter ‘Loan Amount’ and it is to be compared against an entered numeric value of ‘200000’ using the operator ‘>=’. The system administrator chooses the connector ‘AND’ to combine multiple lines together in the rule. Next, the calculation of the adjustment is defined by entering an amount in the value field. Thus, an adjustment equal to the value shown in the value field will be added to selected rate.

Fees are separate amounts, which if applicable, are applied to the price. Fees are defined independently of the rate and adjustments. Fees can be effective dated so that multiple fees are active at the same time. Fees contain three components: applicability, calculation and disposition. Fee applicability defines whether a fee should be applied to the price.

Fee applicability (i.e., the condition for receiving a fee) is a rule defined using Boolean logic. However, the rule definition is not limited to Boolean logic. If the Fee applicability rule results in a positive or true outcome, the fee will be applied to the product. If the rule results in a negative or false outcome, the fee will not be applied to the product.

In the calculation of fees, mathematical operations can be used within the rule to calculate the fee amount. Negative calculation can be provided to cause a deduction or discount to the price. A minimum or maximum amount could be included when defining a fee.

Fee disposition indicates how a fee is paid. Examples of dispositions are payment upon closing, paid by employer, and waived. Similar to the condition for receiving a fee, the condition for possible fee disposition is set up using Boolean logic. However, the rule definition is not limited to Boolean logic. An individual fee can be defined by the system administrator to have many possible dispositions, only one of which will be applicable. Each disposition is defined with a Boolean logic rule determining the condition for receiving the disposition. In addition, one disposition is defined as the default disposition when no other dispositions meet the conditions. Fees are only assigned one disposition in pricing requests.

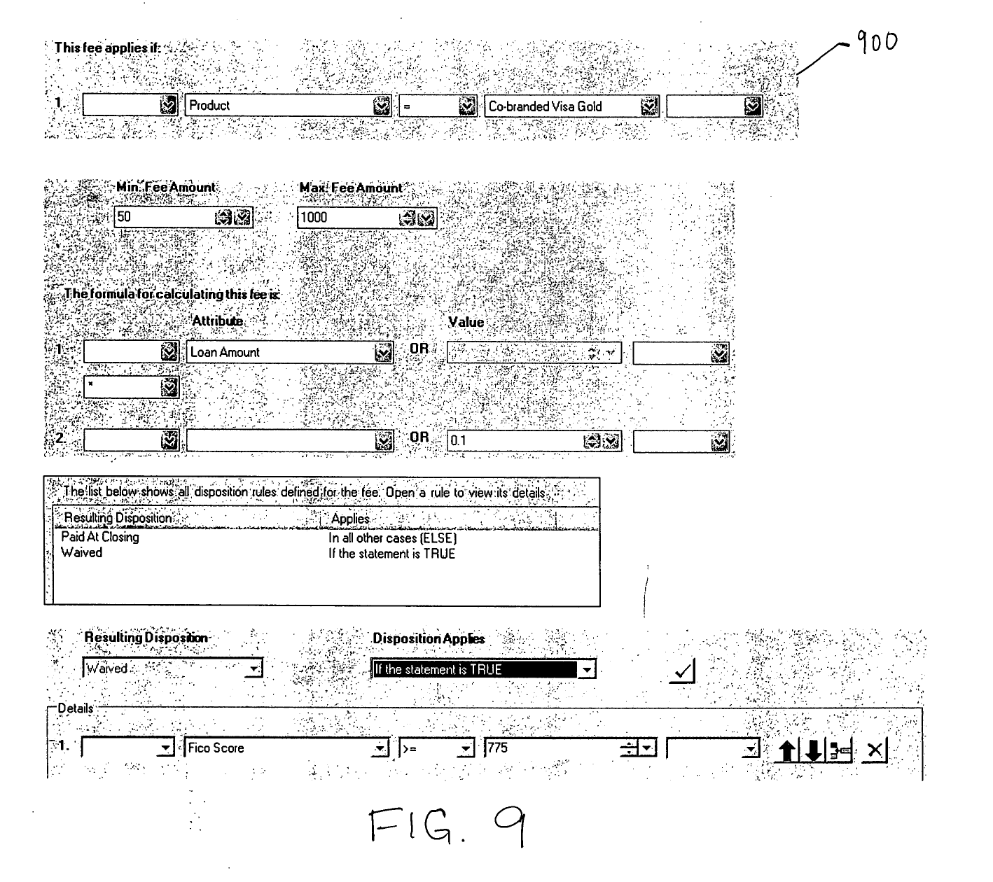

FIG. 9 is a computer display 900 illustrating how applicability rules for fees are entered, according to an embodiment of the present invention. The applicability rule in FIG. 9 indicates, for example, that if the product is ‘Co-branded Visa Gold’ credit card, then a fee does apply. However, if the product is not ‘Co-branded Visa Gold’, then the fee does not apply. This fee is to be waived if the customer's FICO score is greater than or equal to 775 (see bottom portion of FIG. 9). To implement this rule within the pricing engine 20, the system administrator selects customer information parameter ‘Product’ in the first field. Then, it is to be compared against an entered value of ‘Co-branded Visa Gold’ using the operator ‘=’. Next, the calculation of the fee is defined by selecting a customer information parameter ‘Loan Amount’. Selecting an operator of ‘*’ to indicate a multiplication calculation, and a value of ‘0.1’ to result in a 10% calculation. To implement the disposition rule for the fee, the system administrator selects FICO Score parameter in the first field in line 1. Then it is to be compared against an entered value of 775 using the operator ‘>=’.

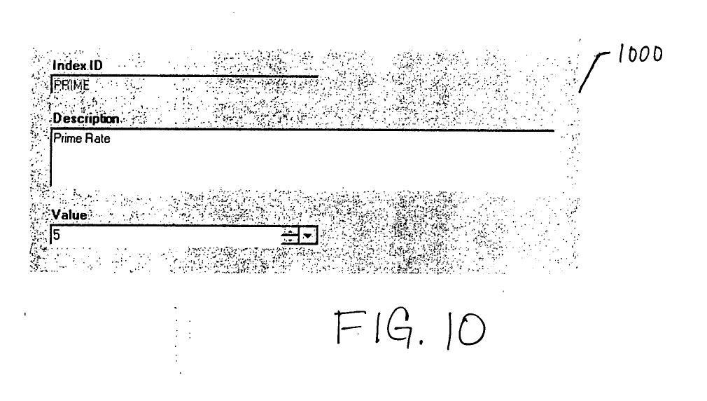

FIG. 10 is a computer display 1000 illustrating how to define an index, according to an embodiment of the present invention. Indices are used in the calculation of variable rates. Indices can be entered and maintained via the GUI 21. For example, as shown in FIG. 10, an ‘Index ID’ is a name of the index, ‘Description’ is a detailed description of the index, and ‘Value’ defines a number value of the index.

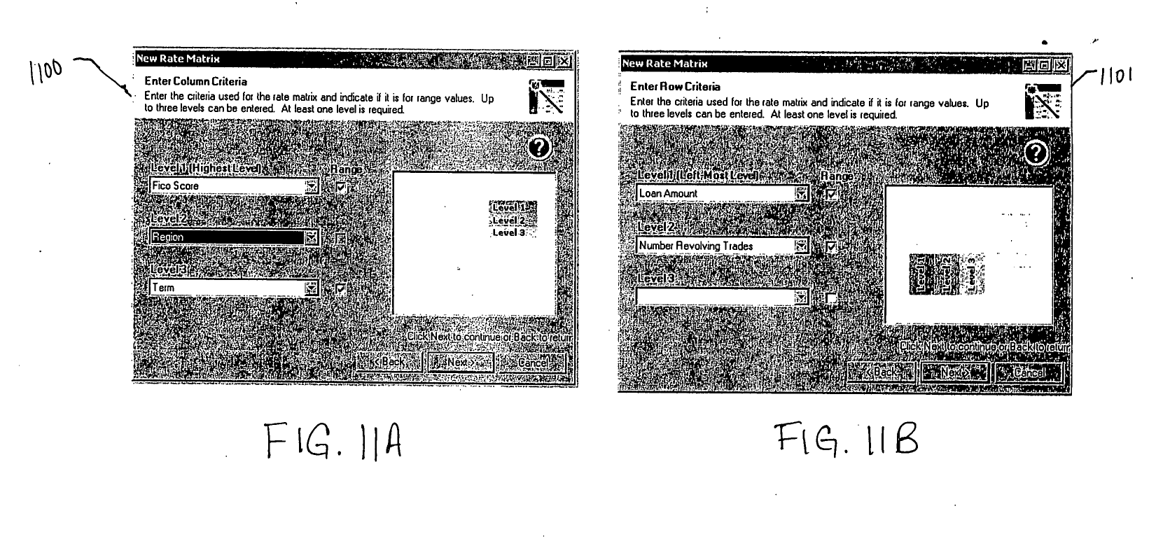

FIGS. 11A and 11B are computer displays 1100 and 1101, illustrating how to define a rate matrix in the pricing engine, according to an embodiment of the present invention. Rate matrices are used to determine the rates applicable to a loan product. As shown in FIGS. 11A and 11B, the computer displays 1100 and 1101 allow a user to create a rate matrix by specifying criteria to determine the rate. Rate matrices can be effective-dated, to allow for multiple rate matrices to be valid at the same time.

Specifically, FIGS. 11A and 11B illustrate how to define a rate matrix. The user is prompted by the GUI 21 to create a rate matrix and asked to define which customer info parameters are used in the rate matrix configuration. Specifically, FIG. 11A illustrates how columns of the rate matrix are defined. FIG. 11B illustrates how rows of the rate matrix are defined. The fields selected for the columns and rows are customer information parameters as stored in the customer information parameter unit 54 shown in FIG. 3. The range field indicates if the cell of the matrix will have a range. As shown in FIGS. 11A and 11B, for example, the computer displays 1100 and 1101, allow up to six dimensions of rate matrix to be defined. However, the present invention is not limited to any particular number of dimensions of the rate matrix, and may vary as necessary. Once the dimensions of the rate matrix are defined, the user can enter the rates and the rate applicability. However, the present invention is not limited to including rate matrices, or rate matrices being created by the system administrator, and may vary as necessary.

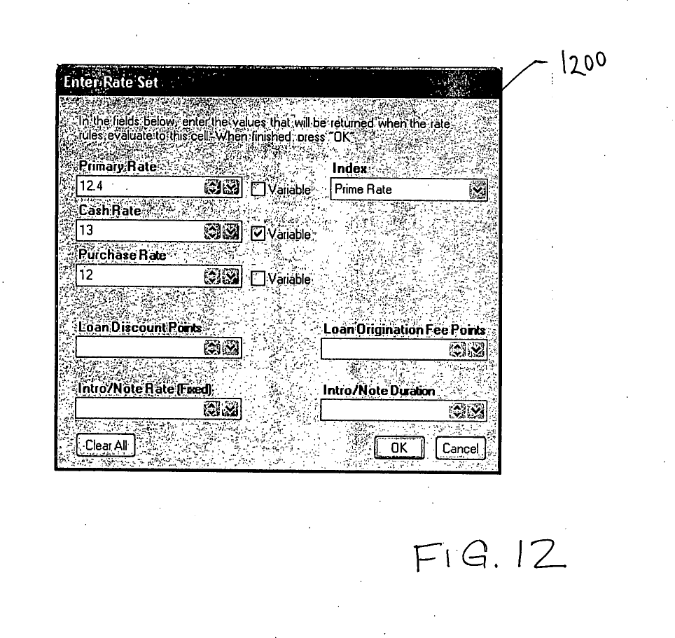

FIG. 12 is a computer display 1200 illustrating how a rate set is entered in a rate matrix in the pricing engine, according to an embodiment of the present invention. As shown in FIG. 12, the system administrator is prompted by the GUI 21 to enter values for rates applicable to the application. For example, a primary rate is used as the interest rate associated to the loan. The Primary rate can be fixed or variable. However, additional rates are optional and can be entered as appropriate based on the product or loan. However, the present invention is not limited to any particular rates and may vary as necessary.

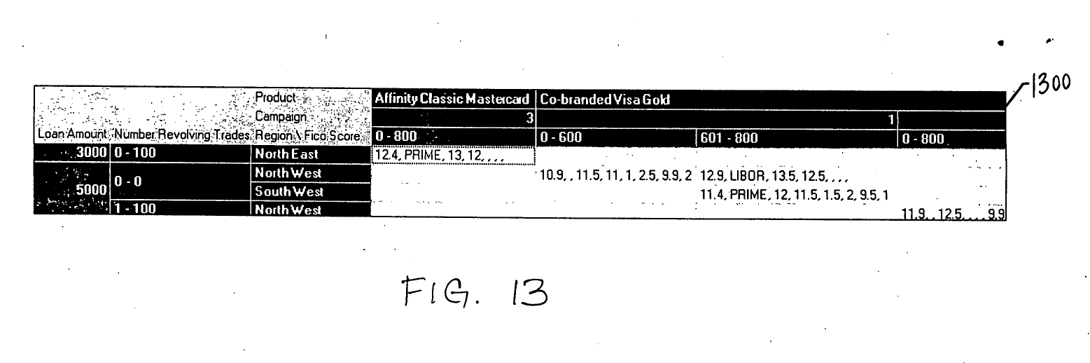

FIG. 13 is a computer display 1300 illustrating an example of a rate matrix, according to an embodiment of the present invention. This is a computer display version of Table 2 above, for returning multiple rates.

In addition to the above-described embodiment, embodiments of the present invention can also be implemented through computer readable code/instructions in/on a medium, e.g., a computer readable medium. The present invention is not limited to any particular platform, and may vary as necessary.

The medium can correspond to any medium/media permitting the storing and/or transmission of the computer readable code. The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. In particular, the media may also be a distributed network, so that the computer readable code is stored/transferred and executed in a distributed fashion.

Additional aspects and advantages of the invention will be set forth in part in the description which follows, and, in part, will be apparent from the description, or may be learned by practice of the invention.

It is another aspect of the present invention to provide a product pricing system comprising a computer-implemented pricing engine being a single software application automatically generating prices for different types of products including adjustments and fees associated with the prices in accordance with pricing attributes including the associated adjustments and fees for the different types of products configurable by a system administrator via a graphical user interface and provided to the pricing engine, wherein when a pricing request is sent to the pricing engine from a product requestor applying for a respective product, the pricing engine automatically generates a price for the respective product in accordance with the pricing attributes provided for the respective product and the pricing request.

It is yet another aspect of the present invention to provide a product pricing system comprising a computer-implemented pricing engine being a single software application automatically generating prices for different types of products in accordance with pricing attributes including rate matrices for the different types of products configurable by a system administrator via a graphical user interface and provided to the pricing engine, wherein when a pricing request is sent to the pricing engine from a product requestor applying for a respective product, the pricing engine automatically generates a price for the respective product in accordance with the pricing attributes provided for the respective product and the pricing request. Reference data and attributes created by the system administrator enable the configuration of the rate matrices.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A product pricing system comprising:
a computer-implemented pricing engine being a single software application automatically generating prices for different types of products in accordance with pricing attributes for the different types of products provided to the pricing engine by a system administrator via a graphical user interface,
wherein when a pricing request is sent to the pricing engine from a product requestor applying for a respective product, the pricing engine automatically generates a price for the respective product in accordance with the pricing attributes provided for the respective product and the pricing request.

2. The product pricing system of claim 1, wherein the price for the respective product includes a single final price or multiple pricing options in accordance with the pricing request.

3. The product pricing system of claim 1, wherein the pricing engine comprises:
a pricing engine maintenance unit to enter and maintain the pricing attributes; and
a pricing engine service unit to determine the price for the respective product based upon the pricing request,
wherein the pricing engine maintenance unit interfaces with the pricing engine service unit such that information stored in the pricing engine service unit is updated in accordance with the pricing attributes maintained in the pricing engine maintenance unit.

4. The product pricing system of claim 3, wherein the pricing attributes comprise multi-dimensional pricing matrices and pricing parameters created by the system administrator.

5. The product pricing system of claim 4, wherein the pricing parameters are configurable and comprise adjustments including adjustment parameters, fees including different types of fees and fee amounts, indices, and federal rates created and input by the system administrator.

6. The product pricing system of claim 4, wherein the multi-dimensional pricing matrices comprise rate matrices created by the system administrator.

7. The product pricing system of claim 5, wherein the adjustments and fees are configurable.

8. The product pricing system of claim 6, wherein the pricing engine service unit comprises a processing unit receiving the pricing request, and processing the pricing request and generating the price for the respective product.

9. The product pricing system of claim 8, wherein the pricing engine service unit further comprises:
a matrix unit to store the multi-dimensional matrices created in the pricing engine maintenance unit;
an adjustment unit to store the adjustments created in the pricing engine maintenance unit;
a fee unit to store the fees entered in the pricing engine maintenance unit;
an index unit to store the indices entered in the pricing engine maintenance unit;
a customer information parameter unit to store pricing criteria to be input by the product requester;
a reference data unit to store the application reference data used to create drop down list to be used by the system administrator when creating the multi-dimensional matrices, wherein the pricing criteria corresponds to the application reference data;
a federal rate unit to store the federal rates; and
a processing rule unit to determine an evaluation process for the processing unit, and whether fees or adjustments are applicable, and forwards the determined evaluation process to the processing unit.

10. The product pricing system of claim 9, wherein the pricing engine service unit further comprises a repository unit which evaluates an applicable rate matrix from the rate matrices stored in the matrix unit, and transfers any applicable rate to the processing unit.

11. The product pricing system of claim 10, wherein the pricing engine service unit processing unit received any applicable rate from the repository unit and calculates a final rate or set of rates corresponding to the pricing request.

12. The product pricing system of claim 1, wherein the pricing engine service unit further comprises a storage unit to store the pricing attributes.

13. The product pricing system of claim 3, wherein the pricing engine service unit determines whether fees and adjustments are applicable, and when applicable, the pricing engine service unit calculates the applicable fees and adjustments and determines a disposition of the applicable fees.

14. The product pricing system of claim 5, wherein the rate matrices are created to determine the price for the respective product, the indices are input to variably calculate the prices, and the adjustment parameters and fees are input to enable a change to the price based on the pricing request.

15. The product pricing system of claim 14, wherein when variably calculating the price, the pricing engine generates the variable price and an index from the indices used to determine the variable price.

16. The product pricing system of claim 1, wherein the different types of products comprise any originating product having a pricing component.

17. The product pricing system of claim 5, wherein the pricing engine maintenance unit automatically prioritizes and overlaps the rate matrices, adjustments, and fees, to thereby allow different rate matrices, adjustments, and fees to be active at a same time.

18. An apparatus comprising:
means for automatically generating prices for different types of products in accordance with pricing attributes for the different types of products provided to the pricing engine by a system administrator via a graphical user interface,
wherein when a pricing request is received from a product requester applying for a respective product, a price for the respective product is automatically generated in accordance with the pricing attributes provided for the respective product and the pricing request.

19. A method for determining prices for different types of products via a computer, the method comprising:
creating and storing pricing attributes for the different types of products;
receiving a pricing request corresponding to a respective product from a product requestor;
automatically processing the received pricing request; and
determining and generating a price for the respective product corresponding to the created, stored pricing attributes for the respective product and the received pricing request.

20. The method of claim of claim 19, wherein automatically processing the pricing request comprises:
identifying applicable rate sheets included in the created, stored pricing attributes;
determining whether the price for the respective product is to be a fixed price or variable price;
determining whether adjustments are applicable and calculating adjustments when applicable;
determining whether fees are applicable and obtaining the fees and a disposition thereof, when applicable; and
calculating the price for the respective product.

21. A product pricing system comprising:
a computer-implemented pricing engine being a single software application automatically generating prices for different types of products including adjustments and fees associated with the prices in accordance with pricing attributes including the associated adjustments and fees for the different types of products configurable by a system administrator via a graphical user interface and provided to the pricing engine,
wherein when a pricing request is sent to the pricing engine from a product requestor applying for a respective product, the pricing engine automatically generates a price for the respective product in accordance with the pricing attributes provided for the respective product and the pricing request.

22. The product pricing system of claim 21, wherein the adjustments and fees are defined independently.

23. The product pricing system of claim 22, wherein reference data and attributes created by the system administrator enable a configuration of the adjustments and fees.

24. A product pricing system comprising:
a computer-implemented pricing engine being a single software application automatically generating prices for different types of products in accordance with pricing attributes including rate matrices for the different types of products configurable by a system administrator via a graphical user interface and provided to the pricing engine,
wherein when a pricing request is sent to the pricing engine from a product requestor applying for a respective product, the pricing engine automatically generates a price for the respective product in accordance with the pricing attributes provided for the respective product and the pricing request.

25. The product pricing system of claim 24, wherein reference data and attributes created by the system administrator enable a configuration of the rate matrices.
